(19) United States
(12) Patent Application Publication
(10) Pub. No.: US 2017/0370715 A1
(43) Pub. Date: Dec. 28, 2017

(54) EXPANDABLE LEVEL

(71) Applicant: Donald E. KENNIS, Aurora, OH (US)

(72) Inventor: Donald E. KENNIS, Aurora, OH (US)

(21) Appl. No.: 15/194,848

(22) Filed: Jun. 28, 2016

(51) Int. Cl. G01C 9/02; G01C 9/26

(52) U.S. Cl. CPC G01C 9/02; G01C 9/26

(57) ABSTRACT

An expandable level includes a pair of extension bodies, with at least one of the extension bodies carrying a level indicator. Each extension body includes a carriage with a carriage cavity, the carriage cavities aligned with each other and having a pair of exterior top surfaces separated by the carriage cavity. A rail is slidably received in both carriage cavities and has a body surface that remains substantially flush with the exterior top surfaces when the pair of extension bodies are adjacent one another and when the pair of extension bodies are spaced apart from one another.

### TECHNICAL FIELD

The present invention is generally directed to a level used for determining whether a workpiece is in a horizontal or vertical plane. In particular, the present invention is directed to an expandable level. More specifically, the present invention is directed to an expandable level that utilizes a straight edge assembly to allow a user to draw a line even though the level is in its expanded condition.

### BACKGROUND ART

As is well known, levels are used to make sure a workpiece is in a horizontal or vertical plane. Ensuring that a workpiece is level to another workpiece for attachment purposes provides for ideal construction practices. If the workpiece is not level, the finished project is likely not structurally sound, and additionally provides, in most instances, an unpleasing appearance.

Different size levels are available depending on a particular application. However, large or long-length levels are too cumbersome to carry in a toolbox. Accordingly, small levels are used, but these levels do not provide, in some instances, an adequate length to provide for a consistent and accurate determination of whether an object is level or not. Additionally, if an edge of the level is used to make a straight line marking, the short length level is not long enough to provide for an adequate mark. As a result, a number of expandable or telescoping levels have been developed. These allow for a small length level to work almost as effectively as a longer level.

One distinct disadvantage of an expandable or telescoping level is that the level does not provide for a straight line edge. In other words, in an expanded condition, the level has a gap between expanded portions and the workpiece which is being analyzed to determine whether it is level or not. As such, once a workpiece or a line to be drawn on the workpiece is determined to be level, a user trying to draw the line to represent that level position will encounter a gap between the portions of the level not adjacent the workpiece and the workpiece. As such, a continuous and accurate straight line edge cannot be obtained. Therefore, there is a need in the art for an expandable level that also provides for a straight line edge adjacent the workpiece.

### SUMMARY OF THE INVENTION

In light of the foregoing, it is a first aspect of the present invention to provide an expandable level.

It is another aspect of the present invention to provide an expandable level, comprising a pair of extension bodies, at least one of the extension bodies carrying a level indicator, each body having a carriage with a carriage cavity, the carriage cavities aligned with each other, and each carriage having a pair of exterior top surfaces separated by the carriage cavity, and a rail slidably received in both carriage cavities, the rail having a body surface that remains substantially flush with the exterior top surfaces when the pair of extension bodies are adjacent one another and when the pair of extension bodies are spaced apart from one another.

Yet another aspect of the present invention is to provide an expandable level, comprising a pair of extension bodies, at least one of the extension bodies carrying a level indicator, each extension body having a carriage cavity and an exterior surface, a rail slidably received in the carriage cavities, the rail having a body surface that remains substantially flush with the exterior surfaces when the pair of extension bodies are adjacent one another and when the pair of extension bodies are spaced apart from one another, and a straight edge assembly slidably secured to the pair of extension bodies so as to provide a straight line edge when the pair of extension bodies are spaced apart from one another.

### BRIEF DESCRIPTION OF THE DRAWINGS

These and other features and advantages of the present invention will become better understood with regard to the following description, appended claims, and accompanying drawings wherein:

FIG. 1 is a perspective view of an expandable level made in accordance with the concepts of the present invention;

FIG. 2 is a perspective view of the expandable level shown in an expanded condition according to the concepts of the present invention;

FIG. 3 is a cross-sectional view taken along lines 3-3 of FIG. 1 showing the expandable level according to the concepts of the present invention;

FIG. 4 is a rear perspective view of the expandable level in the expanded condition in accordance with the concepts of the present invention;

FIG. 5 is an elevational view of the expandable level in the expanded condition according to the concepts of the present invention;

FIG. 6 is a top view of the expandable level in the expanded condition according to the concepts of the present invention;

FIG. 7 is a partial exploded perspective view of selected components of the expandable level illustrating features of a straight edge assembly employed by the expandable level according to the concepts of the present invention;

FIG. 8 is a detailed cross-sectional view of the straight edge assembly according to the concepts of the present invention;

FIG. 9 is a perspective view of an expandable level according to the concepts of the present invention showing an alternative embodiment of the straight edge assembly in accordance with the concepts of the present invention;

FIG. 10 is a partial exploded perspective view showing selected components of the expandable level illustrating features of the alternative straight edge assembly according to the concepts of the present invention; and

FIG. 11 is a detailed cross-sectional view taken along lines 11-11 of FIG. 9 showing the alternative straight edge assembly according to the concepts of the present invention.

### BEST MODE FOR CARRYING OUT THE INVENTION

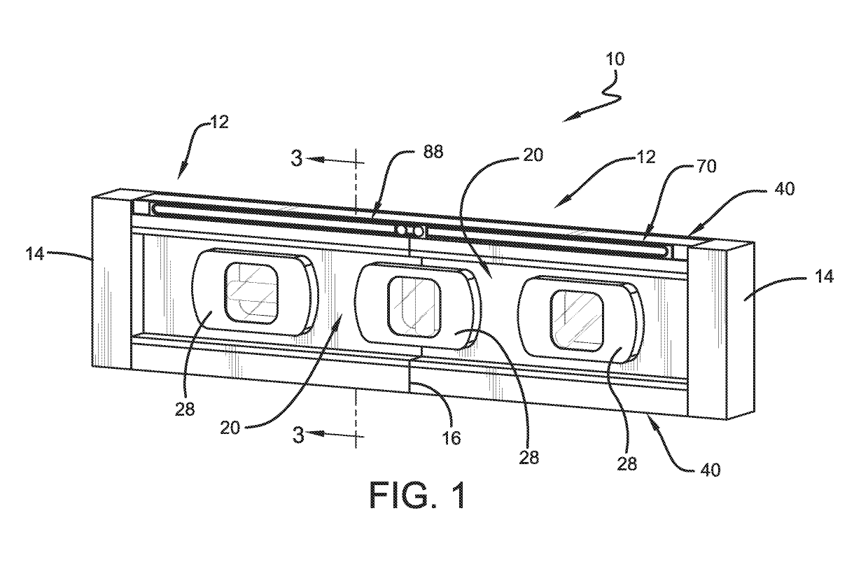

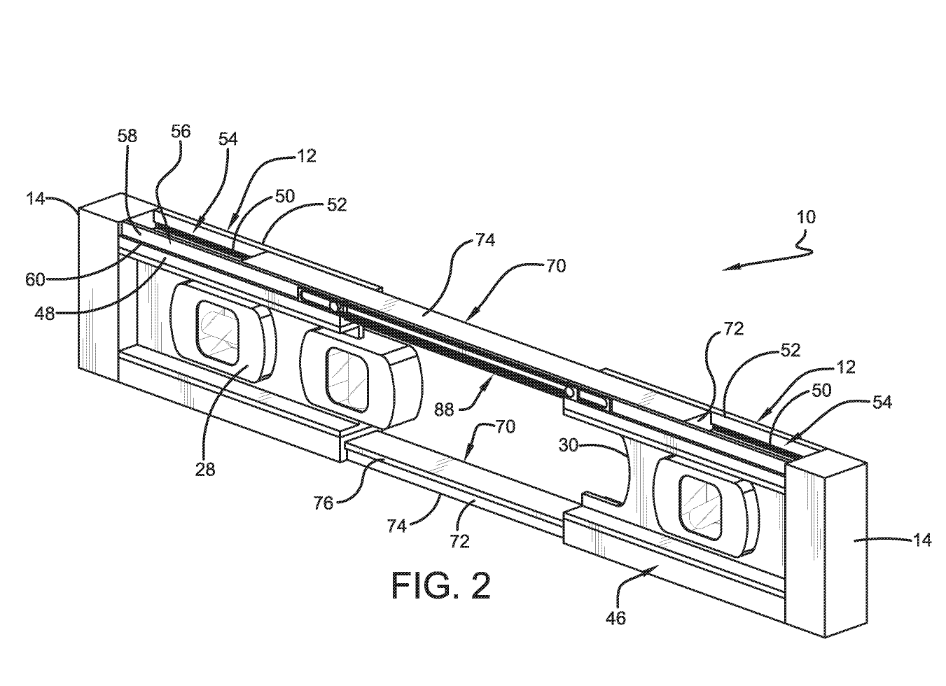

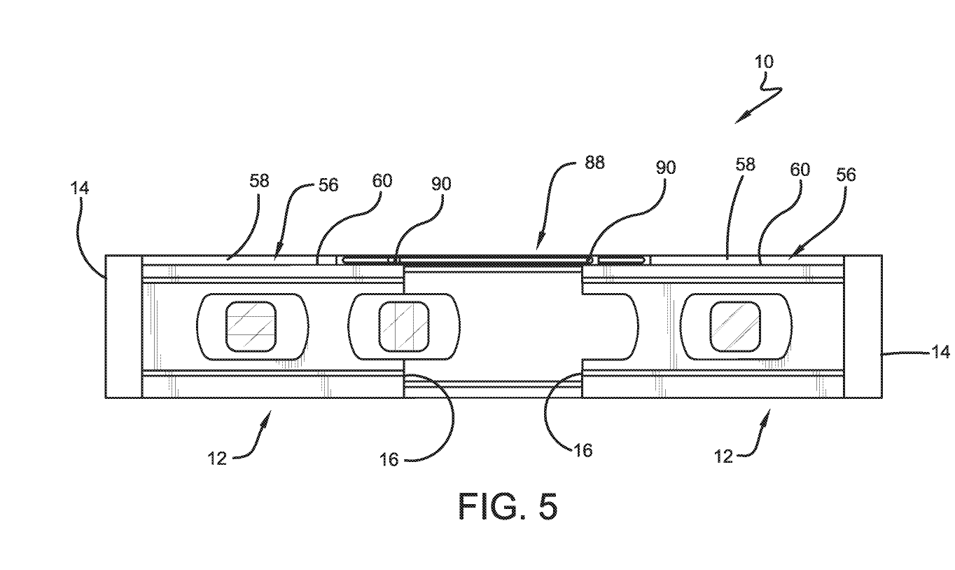

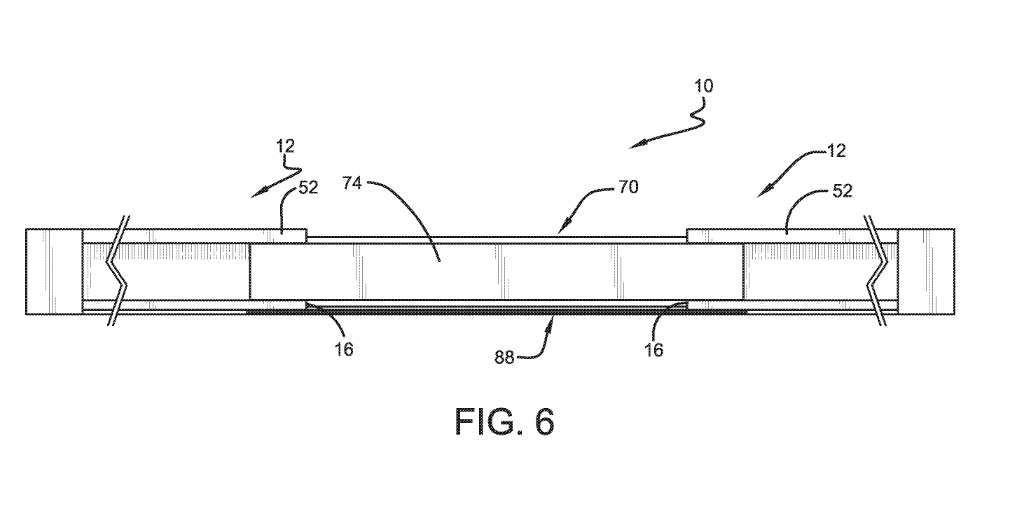

Referring now to the drawings and in particular to FIGS. 1-8, it can be seen that an expandable level according to the concepts of the present invention is designated generally by the numeral 10. The level 10 includes two extension bodies, each designated generally by the numeral 12. For the most part, the extension bodies 12 are mirror images of one another, wherein one of the bodies 12 is shown on the left side of FIGS. 1 and 2 while the other extension body 12 is shown on the right side of FIGS. 1 and 2. Each extension body 12 provides an end 14, wherein each end is at an opposite end of the level 10. Each extension body 12 has a face 16 that is opposite its respective end and which is adjacent each other when the level 10 is in its collapsed position as shown in FIG. 1.

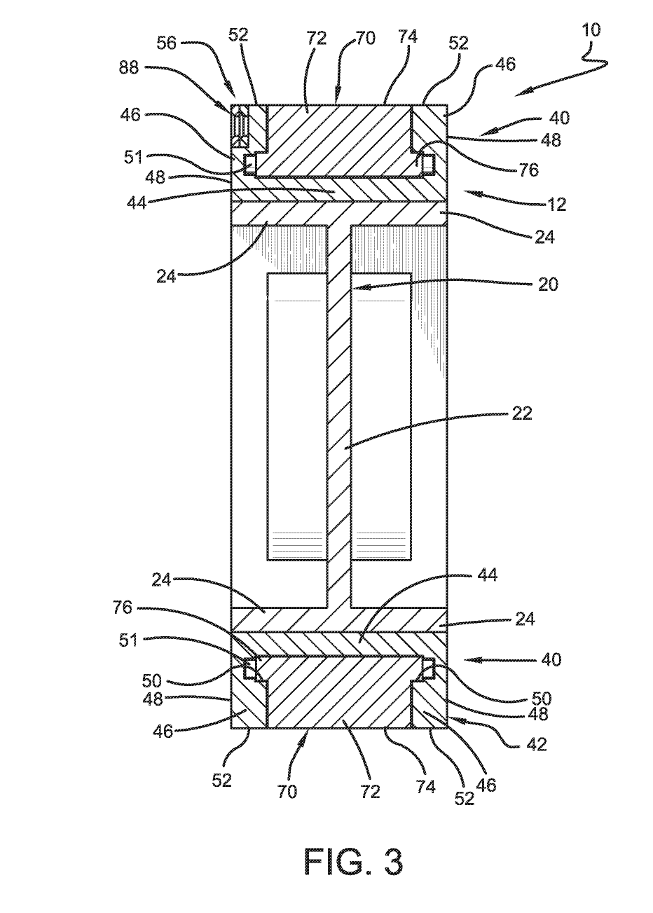

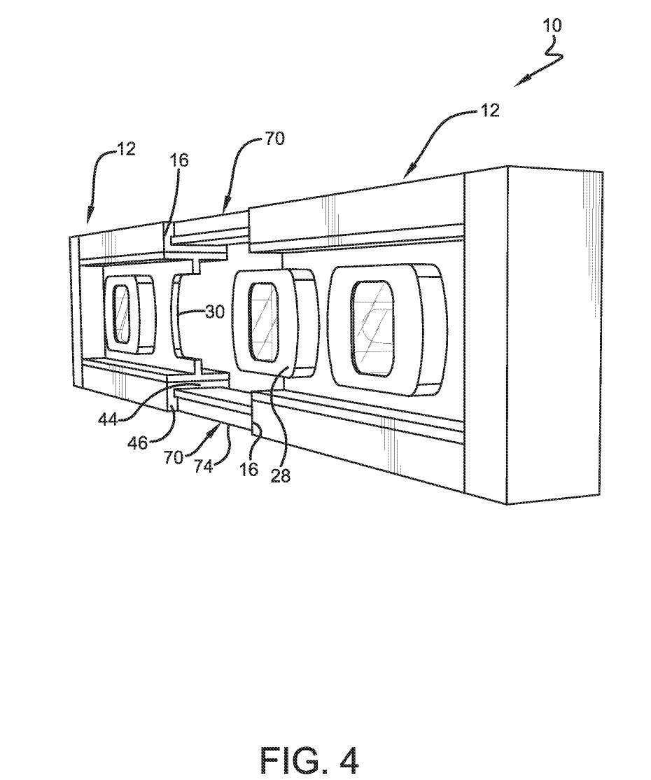

Each extension body provides a web designated generally by the numeral 20. In the embodiment shown, the web is shaped like an I-beam, but it will be appreciated that other structural shapes may be employed. As best seen in FIG. 3, the web 20 provides for a beam 22 which makes up a middle portion of the web. Each web 20 is terminated at one end by the end 14 and at an opposite end by the face 16. Each edge of each beam 22 provides a pair of substantially perpendicularly extending shoulders 24. The beam 22 carries at least one level indicator designated generally by the numeral 28. The level indicators may be of the bubble configuration, but other configurations may be employed. In the embodiment shown, one of the level indicators is partially carried at the face 16 of one of the extension bodies and a corresponding notch 30 in the other extension body receives the other portion of the level indicator when the extension bodies are spaced apart from one another as shown in FIGS. 2 and 4.

Secured to each shoulder of the extension bodies 12 on both sides thereof may be an extension member 40. The extension members 40 may be welded, adhesively secured, or in some embodiments, integral with the shoulders 24. The extension member 40 includes a carriage 42 which is generally U-shaped in cross-section. The carriage includes a base 44 which may extend from the end 14 to the face 16. Extending substantially perpendicularly from the base 44 are a pair of opposed arms 46. Each arm 46 provides an exterior side surface 48 that faces outwardly. In the embodiment shown the exterior side surfaces 48 are substantially flush with an outer exterior edge of each shoulder 24. In some embodiments, the exterior side surface 48 may extend beyond the outer exterior edge of the corresponding shoulder 24. Skilled artisans will appreciate that the extension members 40 will all be of substantially the same width.

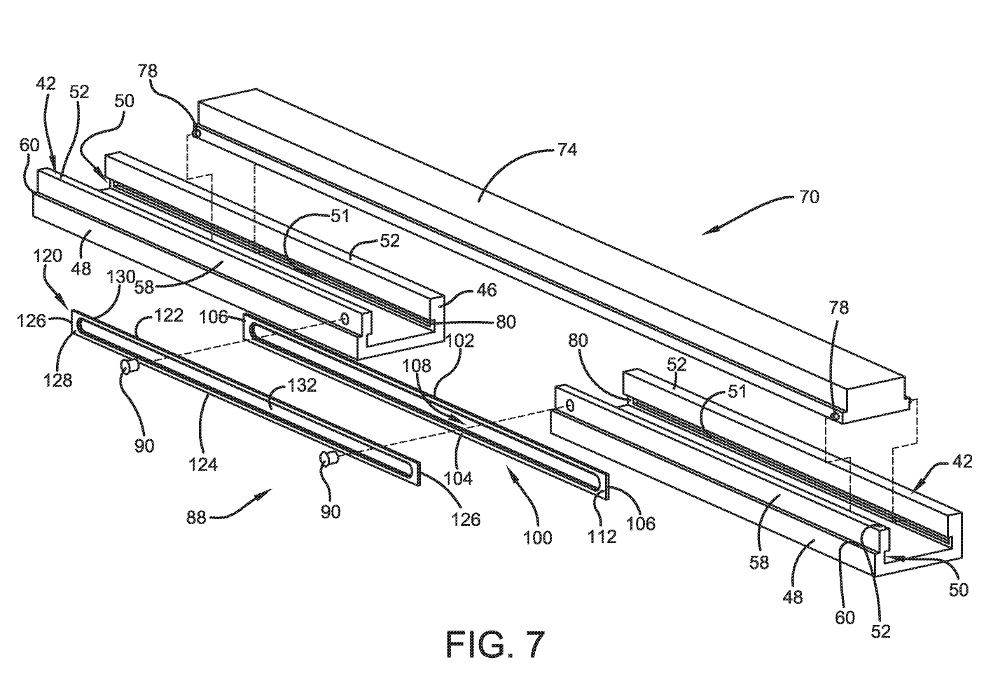

Each arm 46 maintains a channel 50 therein which extends substantially along the entire length of each arm 46, wherein the channel in one arm faces the channel in the other facing arm. Each channel 50 may further provide a trough 51. Each arm 46 also provides an exterior top surface 52 which is substantially perpendicular to the exterior side surface 48. In any event, the channel 50 may be disposed anywhere along the arm, but in the embodiment shown the channels are positioned proximally near the base 44. The arms 46 are opposed to one another and form a carriage cavity 54. As best seen in FIG. 3, one side of a single arm 46 along the adjacent exterior side surface 48 and the exterior top surface 52 provides for a groove 56. Although the groove 56 is only shown in relation to one of the arms 46, it will be appreciated by skilled artisans that the groove 56 may be provided on any one or all of the outer corners of the arms 46. As best seen in FIG. 7, each groove 56 is formed by a wall 58 that extends perpendicularly downwardly from the exterior top surface 52. Extending substantially perpendicularly from the wall 58 is a ledge 60 which extends to the outwardly facing exterior side surface 48 of the arm 46. Further details about the groove 56 will be discussed later.

Slidably received in the carriage cavity 54 is a rail designated generally by the numeral 70. The rail 70 includes a body 72 which has a body surface 74. In the embodiment shown, the body surface 74 is substantially flush with the exterior top surface 52 provided by the respective arms 46. As such, it will be appreciated that together the exterior top surfaces 52 and the body surface 74 provide a substantially flat planar surface for the level 10 when it is applied to a workpiece or object to determine whether the workpiece is in a level condition or not. At a lower edge of the body 72 may be a pair of opposed ribs 72. As best seen in FIG. 3, the ribs 76 are slidably received in the respective channels 50. Further extending from each rib 76 at one end thereof may be a knob 78. Each knob 78 is slidably received in the corresponding trough 51. The knob 78 may be a fixed outwardly extended pin or a spring-loaded pin that can be pushed inwardly to facilitate insertion of the rail 70 into the carriages 42 and specifically the carriage cavities 54. The knobs 78 are employed to catch on an end surface provided by each channel so that the extension bodies do not become disconnected from the rails 70 when the level is expanded. Skilled artisans will appreciate that other retention mechanisms may be employed so as to keep the extension bodies and the rail associated with one another.

As presented, the level 10 provides a rail 70 that may be slidably received in both carriage cavities along opposed sides of the extension bodies. Each rail has a body surface 74 that remains substantially flush with the exterior top surface 52 of the arms when the pair of extension bodies are adjacent one another. When the extension bodies 12 are spaced apart from one another, the exterior top surface 52 of the arms remain flush with the body surface 74 of the rail in those positions where the rail 70 is still received in the carriage cavity 54. This is in distinct contrast to prior art expandable levels which utilize a telescoping feature or other configuration wherein the surface of the level that is maintained adjacent the object being evaluated has a significant gap therebetween which does not permit a user to draw a straight line for later positioning and then attaching another piece of material to the first piece of material. Skilled artisans will appreciate that the width of each arm 46 may be minimized so that when the extension bodies are spaced apart from one another, only a minimal gap between the rail and the workpiece surface upon with the level is placed is generated. As such, the expanded level 10 can provide a substantially straight edge that can be used when marking a straight line on the workpiece.

To further assist and ensure that a straight edge can be provided by the level when it is in an expanded condition, a straight edge assembly designated generally by the numeral 88 may be provided with the level 10. In such a configuration, the straight edge assembly 88 allows for the extension bodies to be separated from one another and provide for a straight line edge in substantially the middle portion of the expanded level that is in substantially touching contact with the adjacent workpiece.

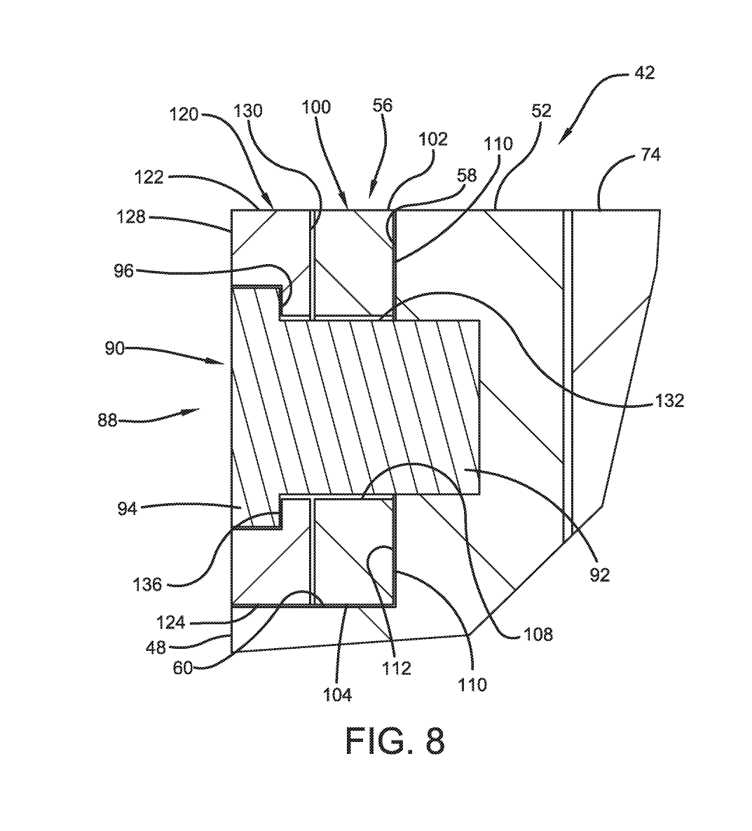

The straight edge assembly 88 may be received in one or all of the grooves 56 provided by each extension body 12. A pin 90 may extend from the wall 58 near the face 16 of each extension body. Specifically, as best seen in FIGS. 7 and 8, each pin 90 is connected to a corresponding wall 58. Each pin 90 has a shaft 92 and a pin head 94 connected to the shaft. The effective outer diameter of the pin head is larger than the effective outer diameter of the shaft. The shaft 92 may be a threaded member for connection to the wall or the shaft may be fastened by other means. Each pin head 94 may provide an underside surface 96. In some embodiments the underside 96 may be a chamfered configuration instead of a substantially perpendicular configuration as shown. The pin 90 may be connected to the wall 58 such that the pin head 94 is substantially flush with the exterior side surface 48 of the arm 46. In other words, the pin head 94 and the exterior side surface 48 are coplanar so that the level, when positioned on its side, lies substantially flat on the workpiece.

The straight edge assembly 88 also includes an inner frame 100 and an outer frame 120 that are both slidably secured by the pins 90 to the extension bodies. The inner frame 100 includes an external edge 102 which is aligned and substantially flush with the exterior top surface 52 of the arm 46. Opposite the external edge 102 is an internal edge 104 which is maintained slidably adjacent the ledge 60 provided by the groove 56. The edges 102 and 104 are connected by corresponding sides 106. The inner frame 100 provides an arm surface 110 that faces the wall 58. The inner frame 100, opposite the arm surface 110, provides a frame surface 112. The inner frame 100 maintains an elongated slot 108 that extends from the arm surface 110 to the frame surface 112. The slot 108 is sized to allow for slidable movement past the shafts 92.

The outer frame 120 provides for an external edge 122 that is aligned and substantially flush with the exterior top surface 52 of the arm 46. Opposite the external edge 122 is an internal edge 124 which is maintained slidably adjacent the ledge 60. The edges 122 and 124 are connected to one another by opposed sides 126. The outer frame 120 includes an outer surface 128 that is substantially flush with the exterior side surface 62 of the arm 46. The outer frame 120 also provides a facing surface 130 that is positioned slidably adjacent to the inner frame's outwardly facing frame surface 112. Extending through the outer frame 120 is an elongated slot 132 which is sized to be slightly larger than the diameter of the shafts 92. Extending from the slot 132 is a step 136 that extends substantially along the entire length of the slot 132. The step 136 is positioned adjacent the pin's underside 96. As a result, the pin head 94 functions to capture and slidably maintain the outer frame 120 and the inner frame 100 within the groove 56.

In operation, when the user positions the level on a workpiece to determine whether it is level or not, the level provides for a straight edge assembly upon which the user can make an appropriate straight line marking. If needed, the level can be expanded by pulling the two extension bodies apart from one another. As this occurs, the extension bodies slide apart and are slidably supported by the rail 70 which is maintained within the respective carriage cavities 54. As the extension bodies are pulled apart from one another the straight edge assembly 88, which is maintained within the groove 56, expands accordingly with the extension bodies. Eventually, at least one of the pins 90 engages the inner and/or outer frames so that they likewise pull apart. This pulling apart however maintains a straight edge in between the extension bodies so that a straight line marking can be obtained.

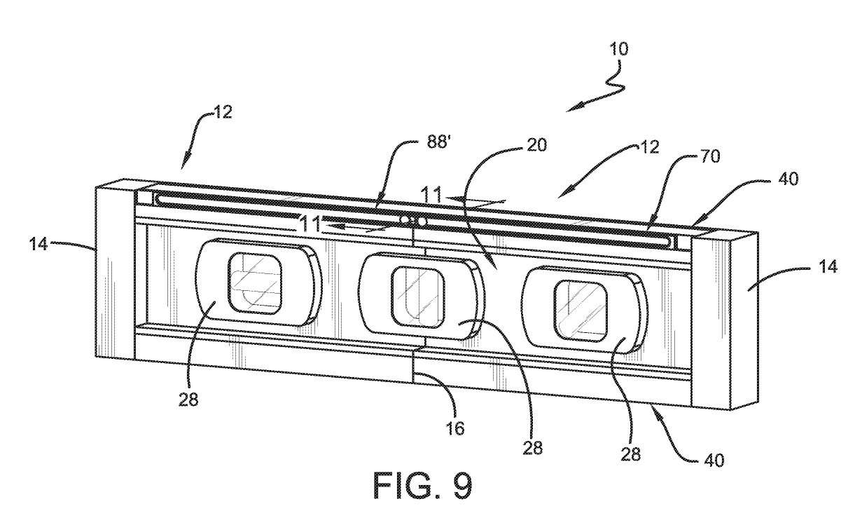

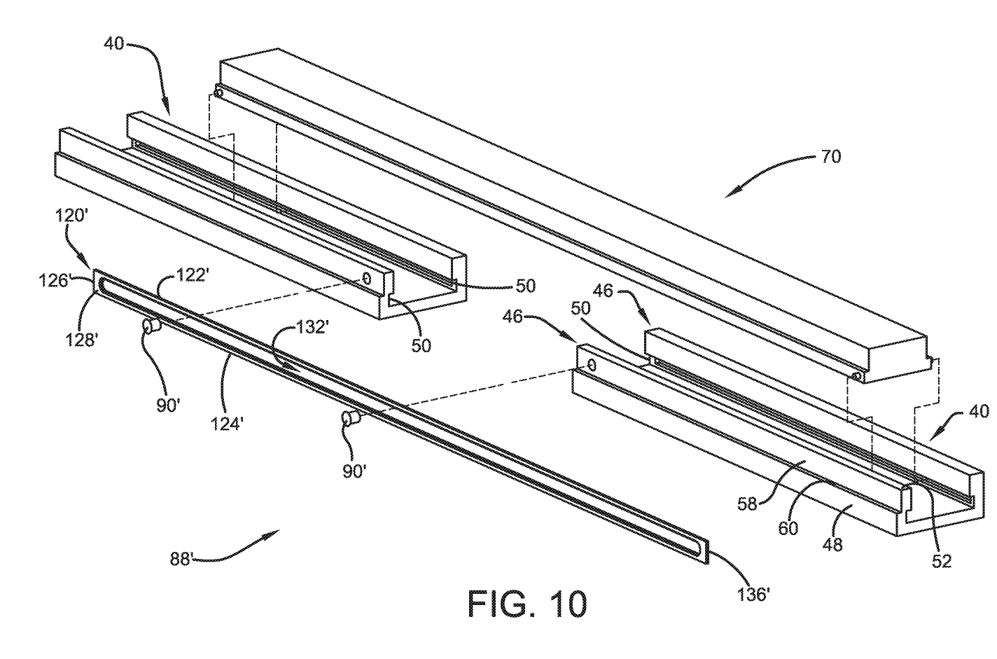

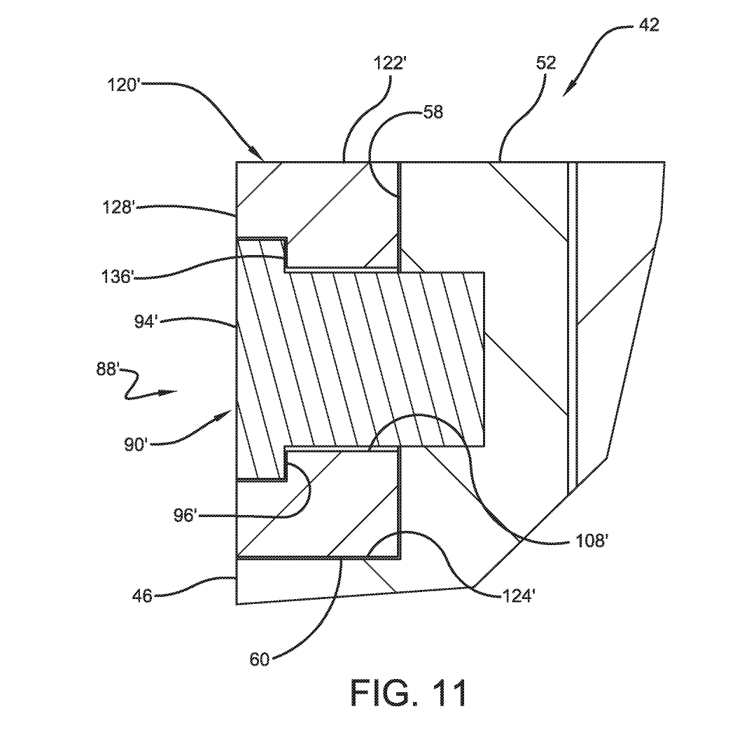

Referring now to FIGS. 9-11, it can be seen that an alternative straight edge assembly designated generally by the numeral 88′ may be provided. In this embodiment, prime numbers are utilized to indicate components which are similar to the components shown in the prior embodiment. In this embodiment, instead of utilizing an inner frame and an outer frame, only a single outer frame is provided. An outer frame 120′ extends substantially the entire length of the two extension bodies and, as such, allows for the level to be expanded further than provided by the previously described straight edge assembly 88. As such, the outer frame 120′, in a manner similar to the previously described outer frame, provides for an external edge 122′ that is substantially aligned and flush with the exterior top surface 52. Opposite the external edge 122′ is an internal edge 124′ which is maintained slidably adjacent the ledge 60. Each of the edges 122′ and 124′ are connected by sides 126′. The outer frame 120′ provides for an outer surface 128′ that is maintained substantially flush with the outer surface 48 and a surface of the pin head. The outer frame 120′ provides for a slot 132′ that extends substantially therethrough. Extending from the slot 132′ is a step 136′ that may extend substantially along the entire length of the slot. As in the previous embodiment, the slot 132′ is sized to be slightly larger in width than the diameter of the shafts 92. The pin head 94′ is sized to be larger than the width of the slot 132′ such that the underside 96′ is slidably adjacent the step 136′ so that the outer frame 120′ is held slidably in place. Accordingly, in this embodiment the extension bodies are allowed to extend as far as the length of the slot 132′. In other words, the pins will travel within the slot until they come in contact with the end of the respective ends of the slot 132′.

This configuration allows for the level to be extended a larger amount than the previous embodiment. Otherwise the advantages are substantially the same in that the straight edge assembly provides for a straight line for marking a workpiece whenever the level is fully expanded. And in both embodiments of the slide edge assembly 88 and 88′, the assembly assists in maintaining the extension bodies 12 associated with one another.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. An expandable level, comprising:
a pair of extension bodies, at least one of said extension bodies carrying a level indicator, each said body having a carriage with a carriage cavity, said carriage cavities aligned with each other, and each said carriage having a pair of exterior top surfaces separated by said carriage cavity; and
a rail slidably received in both said carriage cavities, said rail having a body surface that remains substantially flush with said exterior top surfaces when said pair of extension bodies are adjacent one another and when said pair of extension bodies are spaced apart from one another.

2. The level according to claim 1, wherein each said carriage comprises:
a base, and
a pair of arms upwardly extending from said base, wherein said base and said arms form said carriage cavity, said arms each having a channel that faces one another; and
wherein each said rail comprises:
a body having said body surface; and
a pair of opposed ribs extending from said body,
wherein each said rib is slidably received in a corresponding one of said channels.

3. The level according to claim 2, wherein each said extension body comprises:
a web having opposed beam edges;
a pair of shoulders extending substantially perpendicularly from each said beam edge; and
an extension member associated with each said pair of shoulders, wherein said extension member maintains said carriage.

4. The level according to claim 3, wherein each said extension body has a face, wherein said faces are in close proximity to one another when said pair of extension bodies are adjacent one another.

5. The level according to claim 1, further comprising:
a straight edge assembly slidably secured to said pair of extension bodies so as to provide a straight line edge when said pair of extension bodies are spaced apart from one another.

6. The level according to claim 5, wherein each said carriage has a groove, and wherein said straight edge assembly is received in said grooves.

7. The level according to claim 6, wherein said straight edge assembly further comprises:
an elongated frame having a slot;
a pin extending from each said extension body into said groove such that said pin extends into said slot so as to slidably retain said elongated frame.

8. The level according to claim 7, wherein said frame comprises:
an external edge that is positioned by said pins such that said external edge is maintained in a substantially flush position with said carriage's exterior top surface when said pair of extension bodies are spaced apart from one another.

9. An expandable level, comprising:
a pair of extension bodies, at least one of said extension bodies carrying a level indicator, each said extension body having a carriage cavity and an exterior surface;
a rail slidably received in said carriage cavities, said rail having a body surface that remains substantially flush with said exterior surfaces when said pair of extension bodies are adjacent one another and when said pair of extension bodies are spaced apart from one another; and
a straight edge assembly slidably secured to said pair of extension bodies so as to provide a straight line edge when said pair of extension bodies are spaced apart from one another.

10. The level according to claim 9, wherein each said exterior surface has a groove, and wherein said straight edge assembly is received in said grooves.

11. The level according to claim 10, wherein said straight edge assembly comprises an elongated frame, which has an external edge that is in a substantially flush position with said carriage when said pair of extension bodies are spaced apart.

12. The level according to claim 9, wherein each said extension body comprises:
a pair of opposed upwardly extending arms which form said carriage cavity;
each said arm having a top exterior surface that is substantially perpendicular to a side exterior surface;
each said extension body having corresponding arms with a groove at said top exterior surface and said side exterior surface, wherein said straight edge assembly is received in said grooves.

13. The level according to claim 12, wherein said straight edge assembly comprises:
an inner frame having an elongated inner frame slot;
an outer frame having an elongated outer frame slot, said inner frame and said outer frame slidably received in said grooves;
a pin connected to and extending from each said arm having said corresponding groove;
each said pin extending through said elongated inner and outer frame slots.

14. The level according to claim 13, wherein said outer frame has an outer surface that is substantially flush with said exterior side surfaces, and an external edge that is substantially flush with said exterior top surfaces.

15. The level according to claim 12, wherein said straight edge assembly comprises:
an outer frame having an elongated outer frame slot; and
a pin extending from each said arm having said corresponding groove, each said pin extending through said elongated outer frame slot.

16. The level according to claim 15, wherein said outer frame has an outer surface that is substantially flush with said exterior side surfaces, and an external edge that is substantially flush with said exterior top surfaces.
